(19) United States
(12) Patent Application Publication
(10) Pub. No.: US 2025/0374943 A1
(43) Pub. Date: Dec. 11, 2025

(54) METHODS OF CONVERTING PRODUCE TO USABLE FOOD DERIVATIVES

(71) Applicant: Clemson University Research Foundation, Clemson, SC (US)

(72) Inventors: Pushparajah Thavarajah, Pendleton, SC (US); Dil Thavarajah, Pendleton, SC (US)

(21) Appl. No.: 19/230,222

(22) Filed: Jun. 6, 2025

Related U.S. Application Data
(60) Provisional application No. 63/656,752, filed on Jun. 6, 2024.

(51) Int. Cl. A23L 19/00; A23B 7/02

(52) U.S. Cl. CPC A23L 19/01; A23B 7/0215

(57) ABSTRACT

Provided are methods of converting waste portions of produce to an edible fine powder. The methods include providing a starting material comprising an agricultural produce and cutting the agricultural produce into smaller pieces to increase a surface area, drying the smaller pieces of the agricultural produce to reduce a moisture content of the agricultural produce, and grinding the smaller pieces of the agricultural produce and passing the smaller pieces of the agricultural produce through a sieve.

### CROSS-REFERENCE TO RELATED APPLICATIONS

This application claims priority and is related to U.S. Provisional Application Ser. No. 63/656,752, filed on Jun. 6, 2024, and entitled “METHODS OF CONVERTING PRODUCE TO USABLE FOOD DERIVATIVES,” which is hereby incorporated herein by reference in its entirety.

### TECHNICAL FIELD

The various embodiments herein relate to agricultural produce, and more specifically to agricultural produce waste products and residues, including methods of processing said waste products and residues of the agricultural produce to produce non-perishable food derivatives.

### BACKGROUND

Food loss is a known problem within the produce industry, as produce is highly perishable. Approximately one-third of agricultural produce in the United States is lost and/or wasted during any stage of the farm-to-fork chain, for example, in fields, during transport, in food processing centers, and/or in grocery stores. Portions of those foods, such as stems, peels, and seeds, further become waste materials, due to unsuitability for packaged food distribution, poor consumer acceptance, and high vulnerability for spoilage. Food and/or or portions thereof that are ultimately lost and/or discarded (e.g., thrown away, overripe, undesirable, etc.) utilize resources during production, such as, for example, land, fertilizer, water, energy, and costs for transportation, storage, and marketing. This use of resources for food that is ultimately lost/discarded results in a loss of income for farmers and loss of nutritious food products for consumers. Therefore, it is desirable to process the lost and/or discarded portions of agricultural produce to develop a non-perishable, nutritious, and cost-effective food derivative.

### SUMMARY

In Example 1, a method of converting produce to an edible fine powder, may include providing a starting material comprising an agricultural produce and cutting the agricultural produce into smaller pieces to increase a surface area, drying the smaller pieces of the agricultural produce to reduce a moisture content of the agricultural produce, and grinding the smaller pieces of the agricultural produce and passing the smaller pieces of the agricultural produce through a sieve.

Example 2 relates to the method according to Example 1, wherein the smaller pieces of the agricultural produce is reduced to a moisture content of less than 15%.

Example 3 relates to the method according to Example 1 or 2, wherein the agricultural produce comprises kale stems or collard stems.

Example 4 relates to the method according to any one of Examples 1 to 3, wherein the fine powder is a flour having a composition of between about 5% to about 30% proteins.

Example 5 relates to the method according to any one of Examples 1 to 4, wherein the drying temperature is at around 50° C. (Celsius) to around 100° C.

Example 6 relates to the method according to any one of Examples 1 to 5, wherein drying the smaller pieces of the agricultural produce takes around 6 to around 48 hours.

Example 7 relates to the method according to any one of Examples 1 to 6, wherein the smaller pieces of the agricultural produce are less than or equal to one inch in length.

Example 8 relates to the method according to any one of Examples 1 to 7, wherein the fine powder is a flour having a composition of between about 40% to about 70% dietary fibers.

Example 9 relates to the method according to any one of Examples 1 to 8, wherein the flour comprises between about 5% and about 15% fats, minerals, and vitamin micronutrients.

Example 10 relates to a method of converting produce to an edible fine powder, the method including, providing a starting material comprising an agricultural produce and cutting the agricultural produce into smaller pieces to increase a surface area, wherein the smaller pieces are less than or equal to one inch in length, drying the smaller pieces of the agricultural produce to reduce a moisture content of the agricultural produce to less than 15%, and grinding the smaller pieces of the agricultural produce, via a milling process, and passing the smaller pieces of the agricultural produce through a sieve.

Example 11 relates to a composition for animal consumption, the composition comprising flour, wherein at least 80% weight/volume of the flour is derived from secondary food portions.

Example 12 relates to the composition of Example 11 wherein the secondary food portions are comprised of one or more of kale stems, collard stems, and collard stalks.

Example 13 relates to the composition of Example 12 wherein at least 90% weight/volume of the flour is derived from one or more of kale stems, collard stems, and collard stalks.

Example 14 relates to the composition of Example 13 wherein at least 95% weight/volume of the flour is derived from one or more of kale stems, collard stems, and collard stalks.

Example 15 relates to the composition of Example 11 wherein the animal consumption is human consumption.

Example 16 relates to the composition of Example 12 wherein the secondary food portions are comprised of kale stems.

Example 17 relates to the composition of Example 12 wherein the secondary food portions are comprised of collard stems and collard stalks.

Example 18 relates to the method of Example 1 wherein the drying is performed using solar heating.

Example 19 relates to the composition of Example 11 wherein the composition is in a liquid consumable.

Example 20 relates to the composition of Example 11 wherein the composition is green and does not contain dyes or coloring components.

While multiple embodiments are disclosed, still other embodiments of the present disclosure will become apparent to those skilled in the art from the following detailed description, which shows and describes illustrative embodiments of the disclosure. Accordingly, the figures and detailed description are to be regarded as illustrative in nature and not restrictive.

### BRIEF DESCRIPTION OF DRAWINGS

FIG. 1A shows an image of a first agricultural produce, collard stems, with leaves.

FIG. 1B shows an image of a first agricultural produce, collard stems, with leaves removed.

FIG. 1C shows an image of a first agricultural produce, waste collard stems, that are typically discarded. In FIG. 1C, the image shows the smaller pieces of the collard stems after being cut.

FIG. 2A shows an image of a second agricultural produce, kale stems, with leaves.

FIG. 2B shows an image of a second agricultural produce, kale stems, with leaves removed.

FIG. 2C shows an image of a second agricultural produce, waste kale stems, that are typically discarded. In FIG. 2C, the image shows the smaller pieces of the kale stems after being cut.

FIG. 3 shows a flow diagram of a method for converting agricultural produce to an edible fine powder.

FIG. 4 shows a fine powder of collard stems and kale stems, according to one implementation.

FIG. 5 shows a fine powder from collard stems and kale stems, according to one implementation.

FIG. 6A shows an image of collard leaves that are ready for bagging.

FIG. 6B shows an image of kale leaves that are ready for bagging.

FIG. 7 shows an image of the resulting milled powder with a green color.

FIG. 8 is a collection of images of solar dried kale and collard stem material from time=0 through time=3 hours. Collard is on the left for t=0 and kale is on the right. For all other time points, kale is on the left and collard is on the right. 100 g amounts are on the top and 300 g amounts are on the bottom.

FIG. 9 is a collection of images for 300 g amounts of solar dried kale and collard for time=4 hours through time=6.5 hours, and the resulting powder after total drying.

FIGS. 10a and 10b show the environmental conditions for the solar drying.

FIG. 11 illustrates that the resulting flour can maintain its natural green color while dry or while rehydrated.

Various embodiments of the present disclosure will be described in detail with reference to the figures. Reference to various embodiments does not limit the scope of the disclosure. Figures represented herein are not limitations to the various embodiments according to the disclosure and are presented for exemplary illustration of the disclosure.

### DETAILED DESCRIPTION

So that the present disclosure may be more readily understood, certain terms are first defined. Unless defined otherwise, all technical and scientific terms used herein have the same meaning as commonly understood by one of ordinary skill in the art to which embodiments of the disclosure pertain. The embodiments of this disclosure are not limited to particular collard and/or kale fine powders, or processes of drying and milling, which can vary and are understood by skilled artisans. It is further to be understood that all terminology used herein is for the purpose of describing particular embodiments only and is not intended to be limiting in any manner or scope.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, or up to 10%, or up to 5%, or up to 1% of a given value. Alternatively, particularly with respect to biological systems or processes, the term can mean within an order of magnitude, or within 5-fold, or within 2-fold, of a value.

As used herein, the term “substantially free” refers to compositions completely lacking the component or having a small amount of the component that the component does not affect the performance of the composition. The component may be present as an impurity or as a contaminant and/or is present at an amount of less than about 0.5% by weight. In another embodiment, the amount of the component is less than about 0.1% by weight and in yet another embodiment, the amount of component is less than about 0.01% by weight.

The term “weight percent,” “wt. %,” “wt.-%,” “percent by weight,” “% by weight,” and variations thereof, as used herein, refer to the concentration of a substance as the weight of that substance divided by the total weight of the composition and multiplied by 100.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

Disclosed and contemplated herein are methods for converting agricultural produce to an edible fine powder. Various agricultural sources may be contemplated, including, but not limited to lost or wasted portions of agricultural produce. As used herein, the terms “lost portions,” “lost food,” “wasted portions,” and “wasted food” (and corresponding terms “food loss” and “food waste”) refer to agricultural produce and portions thereof that are typically discarded or lost at the food packaging/processing level (in contrast to the type of food waste that occurs as a result of consumer activity at the household level). In embodiments, the agricultural produce may include collards, kale, tubers, other vegetables, fruits, and plants. The discarded portions of said agricultural produce may include, but are not limited to, stems, stalks, peels, seeds, flowers, grains, or the like. In some aspects, the agricultural produce includes the wasted portions of said agricultural produce, such as the portions that typically are not preferred for consumption. The wasted portions may not be preferred for consumption due to texture, appearance, digestibility, or for other sensory effects. However, in some aspects, the wasted portions of said agricultural produce may beneficially provide a good source of dietary fibers, proteins, fats, minerals, and other vitamin micronutrients if processed using the methods as further described herein. In disclosed methods and compositions, the traditionally wasted portions are not waste, and herein can also be referred to as “secondary” food portions.

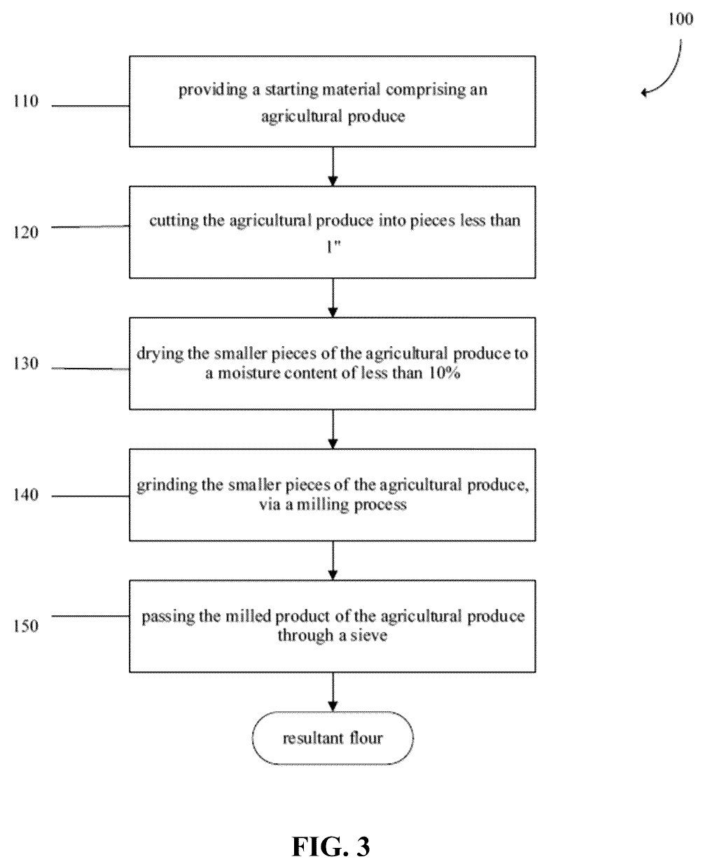

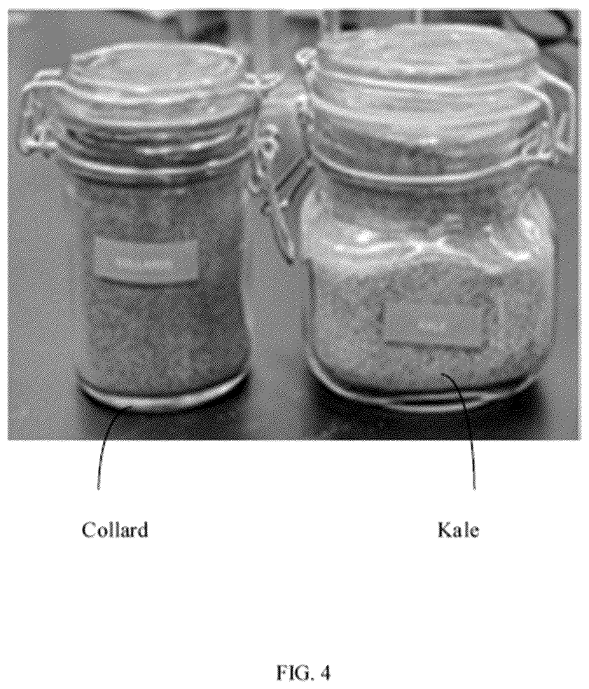

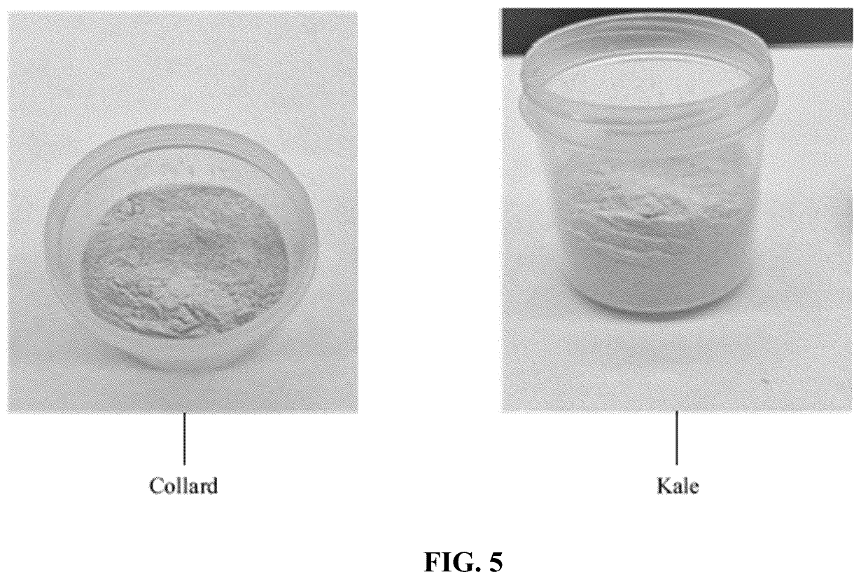

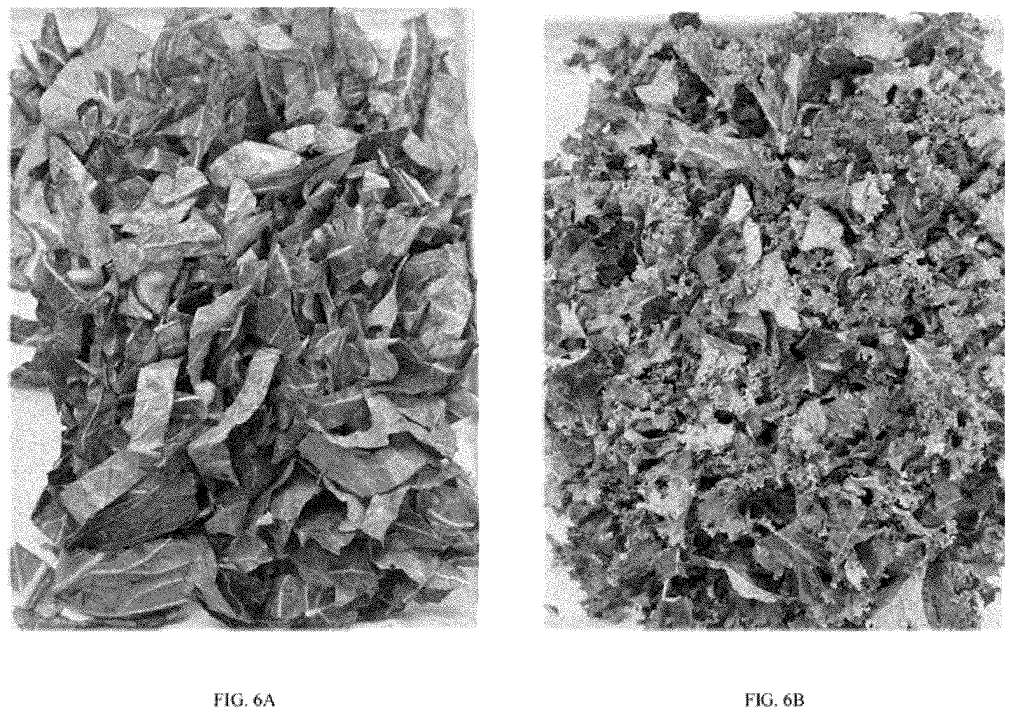

In various embodiments, the methods described herein may yield a dry, fine, sugar-free powder (e.g., flour). FIG. 3 illustrates an example method of processing and converting the wasted portions of the agricultural produce into an edible fine powder, such as flour, according to the disclosure.

Disclosed herein are exemplary processes for producing an edible fine powder. The specific methods discussed herein can be used to produce a fine powder from any known edible agricultural produce. In embodiments, the agricultural produce may include, but not limited to, collards and kale, for example. It is further understood or contemplated that other plants or agricultural produce may include, but not limited to, legumes, tubers, vegetables, fruits, plants, microorganisms, and animal products, for example. Some non-limiting examples of such additional produce that can be used as the starting materials may include lentil, chickpea, field pea, cowpea, pigeon pea, faba bean, mung bean, dry bean, soybean, oats, nuts, sugar beet, corn, sugar cane, sorghum, fish, algae, yeast, bacteria, and other protein rich produce, and including their stems, seeds, flowers, leaves, and by-products. In further examples, the agricultural produce may comprise distiller's dried grains with solubles (DDGS), soybean meal, sugar beet pulp, wheat bran and germs, mill feed, and combinations thereof.

According to certain embodiments, the raw material (agricultural produce) is a plant source. In some aspects, the plant source is the stems of collards and/or kale. However, it is understood that other plants and/or plant parts—such as, for example, the seed, leaf, root, or other part—can serve as the starting plant material.

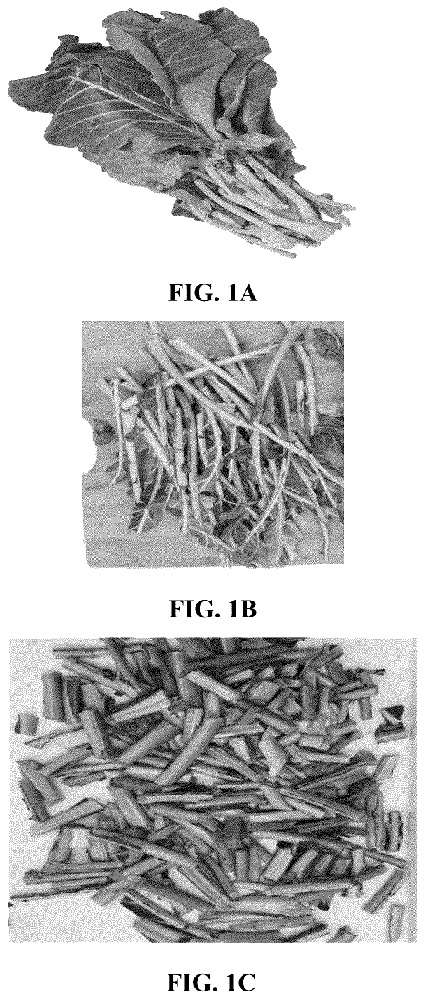

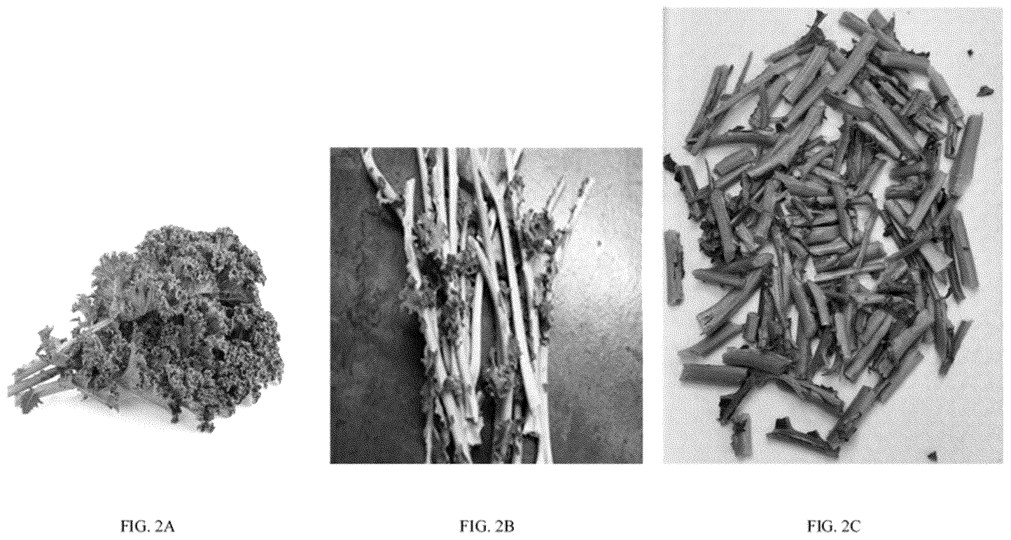

It is understood that, with respect to the methods described herein, according to certain embodiments, the agricultural produce (e.g., collard stems, kale stems) may have the leaves removed from the stems, as shown in FIGS. 1 and 2. The stems may be broken down to smaller pieces (also referred to herein as “the smaller pieces” or “the smaller pieces of the agricultural produce”). The smaller pieces as described and defined herein may further refer to pieces of the agricultural produce having a reduced size from its original form. For example, the smaller pieces may be cut down to a size of about one inch in length. In some cases, the smaller pieces may be less than one inch in length, and in other cases, the smaller pieces may be larger than one inch in length. In some examples, a whole stem may be used. In some examples, the size of the smaller pieces may have a length in the range of about 0.01 inches to about 30 inches, about 0.5 inches to about 25 inches, or any range in between. In embodiments, the size of the smaller pieces may have a length greater than about 30 inches.

In some embodiments, the smaller pieces of the agricultural produce, e.g., the smaller stem pieces, may optionally be subject to a heat treatment prior to milling. In some embodiments, the heat treatment may comprise boiling, roasting, warming, microwaving, radiation, direct and indirect solar heating, hot air, hot water, vacuum drying, or any other form of heating. While the present disclosure is not limited to any particular mechanism of action or theory, it is contemplated that, in some embodiments, raw materials, such as seeds high in fat, may be spoiled by rancidity due to fatty acid oxidizing enzymes. In some aspects, the fatty acid oxidizing enzymes may include, but are not limited to, lipoxygenase enzymes, and other oxidase enzymes. Therefore, in some aspects, the heat treatment may be applied to prevent lipoxygenase enzyme activity and preserve the fatty acids within the composition. In further aspects, additional enzymes that may be responsible for increasing the rate of spoilage of the agricultural produce include proteases or other enzymes that break down proteins, glycolytic enzymes which break down carbohydrates, and enzymes that breakdown phytochemicals, such as those responsible for the breakdown of color and flavor. Therefore, in some aspects, the heat treatment may be applied to inactivate the additional enzymes described herein to preserve flavor and color by inactivating the additional enzymes responsible for spoilage. In some aspects, the overall powder (or flour) product quality resulting from the milling step may be improved due to the heat treatment.

In further aspects, the smaller pieces of the agricultural produce of the disclosure, including the whole seeds, leaves, stems, or by products thereof, may be converted to a dry powder to be directly incorporated into or added to food, beverage, and/or feed applications to increase fiber content, without further need for any chemical or physical modification. In embodiments, the agricultural produce may include, but are not limited to, the whole seeds, leaves, and stems of the agricultural produce, such as, for example, collards and kale. In further embodiments, the agricultural produce may include, but are not limited to, the fruits, stems, leaves, and roots of plant crops (including, but not limited to, artichoke, chicory, etc.).

In certain implementations, the smaller pieces of the agricultural produce may be ground into a fine powder or flour having a particle size of about 1 μm to about 300 μm, about 5 μm to about 250 μm, about 10 μm to about 200 μm, about 10 μm to about 100 μm, about 1 μm to about 250 μm, about 1 μm to about 200 μm, or about 1 μm to about 100 μm. According to some embodiments, the smaller pieces may be ground using a food processor, a known UD cyclone mill, or any other known milling equipment and processes for grinding are possible, as would be appreciated by those of skill in the art. In examples, any wet or dry milling process for converting the agricultural produce to a flour or slurry may be used, including steps of mashing, pulping, or a combination thereof. In further examples, the milling process may include air separation, then a first milling step of the smaller pieces, a first sieving step, a second milling step, dry separation, spray drying, and a second sieving step. After the grinding and/or milling step is complete, the resultant powder or flour may optionally be cooled to about room temperature.

FIG. 3 shows an exemplary process 100 for converting agricultural produce to an edible fine powder. As referenced by block 110, the process 100 begins by providing a starting material comprising an agricultural produce, such as collards and/or kale, or the like. The collards and/or kale used may include the stems of the collards and/or kale that otherwise may have been discarded. The stems of the collards and/or kale may be cut/sliced into smaller pieces to increase a surface area. For example, the collards and/or kale may be placed in a processor, such as a food processor, and cut down to pieces having a size equal to or less than one inch in length, as referenced by block 120. In some cases, a food slicer, a vegetable cutter, or the like may be used. Cutting the stems down to smaller pieces increases the surface area of the stems, thereby aiding in the drying process. As the increased surface area allows for increased exposure to air, thereby increasing the moisture exposed to the air, the process results in decreased drying time.

In further aspects, the smaller pieces may be placed into an oven, or a dryer, such as a commercial dryer, an industrial dryer, or a food dehydrator. In further aspects, the drying may be completed by solar drying, dry heat drying, radiation drying (including, but not limited to, a microwave), freeze drying, spray drying, geothermal energy drying, hot air drying, vacuum drying, or a combination thereof. The smaller pieces of the agricultural produce, such as, but not limited to, the collards and/or kale, are dried at a specific temperature to reduce a moisture content of the smaller pieces of the smaller pieces of the agricultural produce, as referenced by block 130. For example, the smaller pieces of collards and/or kale may be heated in an oven at a temperature of about 50° C. to about 100° C. In some aspects, the temperature may be lowered to less than 50° C. in methods and processes utilizing radiation. The temperature may be chosen to obtain a desired color and/or flavor retention of the resulting fine powder or flour product. For example, lower temperatures (e.g., 60° C.) may result in less browning and/or burning of the smaller pieces of agricultural produce.

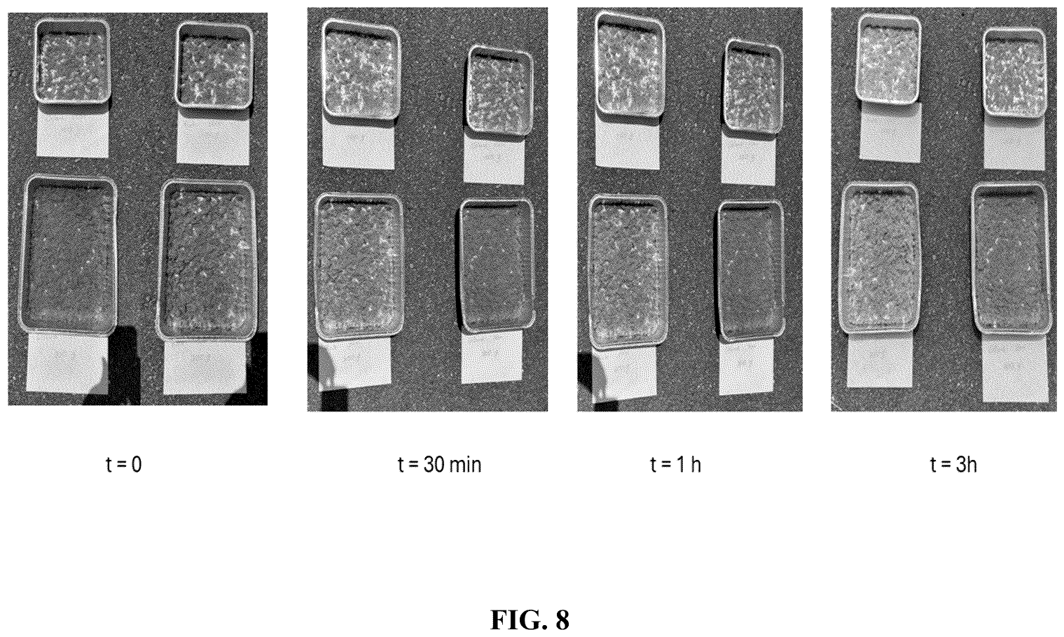

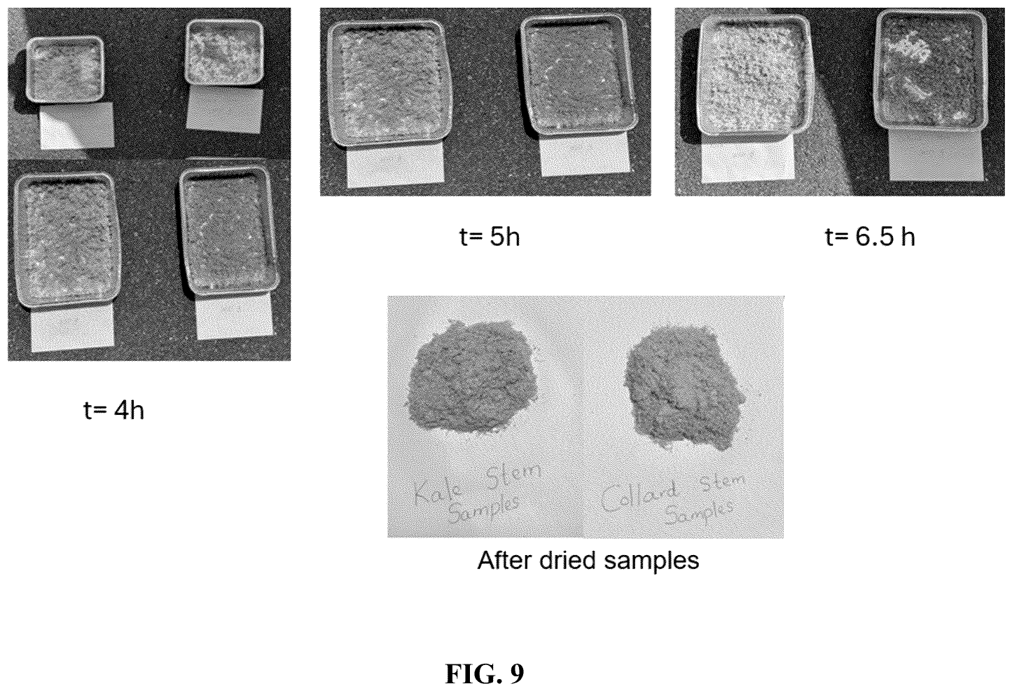

In further aspects, the pieces may be solar dried via direct sunlight directed on the whole parts (stems, etc.), smaller pieces or ground material. Solar dried may has potential advantages, such as of the drying process occurring locally or on-site to the area of growth of the food material. FIG. 8 and FIG. 9 illustrate the process of drying under direct sunlight using 100 g and 300 g of kale stem or collard stem material. The desired color of dried material can be achieved by drying under favorable conditions, taking into account the variables of temperature, UV index, relative humidity, density (mass of material relative to the drying surface area) and time.

The smaller pieces of collards and/or kale may be dried for about 6 hours to about 48 hours. In some cases, a slower drying process may retain a desired color and flavor profile of the resulting product. In some cases, the amount of time the smaller pieces need to be in the dryer is dependent upon the quantity of the smaller pieces placed in the oven. Further, the quantity of the smaller pieces placed in the oven may determine whether or not the smaller pieces need to be turned. For example, if the smaller pieces are arranged in a thin layer, then the smaller pieces may not need to be mixed, and the drying time may be at or around 48 hours. In other aspects, if the smaller pieces are arranged in a thick layer, then the smaller pieces may require turning once daily, twice daily, once every other day, or any other time period as desired. In some aspects, the drying process results in a sample (e.g., smaller pieces of the agricultural produce) having a moisture content of less than 15% for final product stability. In some embodiments, the sample has a moisture content in the range of about 5% to about 15%.

Once the drying process is complete, the smaller pieces of the agricultural produce may be ground using a milling process, into a fine powder. The fine powder may then be passed through a sieve, as referenced by block 140. The smaller pieces of the agricultural produce may be ground using a processor, a milling machine, or any other suitable type of machine. The sieve may be a wire mesh sieve, a stainless-steel mesh sieve, a brass mesh sieve, a sieve shaker, or any other suitable type of sieve. In some aspects, the passing of the milled product or fine powder through the sieve results in a flour composition.

Further provided herein are compositions processed using the methods described herein. In examples, the composition may be a fine powder or a flour. In some aspects, the fine powder or flour are edible fine powders or flours resulting from starting materials considered to be waste or for discard. In examples, the starting materials considered to be waste or for discard may include, but are not limited to, the collard and/or kale stems and by-products as described herein. In some embodiments, the compositions provided herein comprise protein in an amount of between about 5 wt-% to about 30 wt-%.

In further embodiments, the compositions provided herein comprise dietary fiber in an amount of between about 40 wt-% to about 70 wt-%. In some embodiments, if the resulting fine powder or flour are dried using a dry air separation technique, the compositions provided herein may comprise even higher concentrations of dietary fiber, including, greater than 50 wt-%, greater than 60 wt-%, greater than 70 wt-%, or greater than 80 wt-%.

In further embodiments, the compositions provided herein may comprise fats, minerals, vitamin micronutrients, or a combination thereof, in an amount of between about 5 wt-% to about 15 wt-%.

In further embodiments, the compositions provided herein, due to their superior rehydration and suspension qualities, may be used in most food and beverage recipes, including smoothies, shakes, protein or dietary supplements, or as an alternative to traditional corn and wheat-based flours.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure and can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Processing Steps: Stem Cutting Process

The agricultural produce, such as, for example, collard stems and/or kale stems were gathered and prepared to be sliced. In this example, kale stems were used. To start, a Hamilton Beach food processor was used to slice the kale stems efficiently, which were then chopped further using an S-blade on the processor. It may be contemplated that a similar food processor or stem-cutting device could be used to cut the stem into smaller pieces. The processor was turned on high, and the kale stems were fed through the feed chute until it was full enough that the kale was no longer getting to the S-blade. The resulting sample (e.g., stems) were smaller pieces that were less than or equal to one inch in length. By using smaller pieces, the surface area of the stems is increased, which helps in the drying process, as the larger the surface area that is exposed to the air, increases the moisture exposed to the air, aiding in drying time. While it is indicated that smaller pieces of the stems are used, it may be contemplated that stems having a size of greater than one inch in length, or whole stems, may also be used.

### Example 2

### Process Steps: Drying Process

In some embodiments, the drying process could be carried out by oven drying, vacuum drying, or any other dehydrating device. In the example discussed herein, a free-standing oven was used. Drying temperature could be at around 50° C. to at around 100° C., in this case, the free-standing oven was pre-heated to 60° C. (Celsius). In some embodiments a lower temperature is preferable for optimum color and flavor retention. It was found that higher temperatures may cause browning and/or convert the stem pieces to charcoal-like black materials.

While the oven was heating up, metal shelves were lined with aluminum foil. The aluminum foil lined shelves were used to hold the sample of the stem pieces within the oven. The edges of the shelves were left uncovered to allow air to circulate through the oven. A Samson's Brand dehydrator was further used for overflow of the ground sample at 60° C.

Drying time may take from about 6 hours to about 48 hours. The amount of time was dependent on how much of the sample was placed in the oven. In some cases, the sample needed to be mixed (e.g., stirred, flipped, etc.), based on how much of the sample was used, such as, a thin later or a thicker layer. For example, if the amount of sample was a thin layer, the sample may be dried in the oven at 60° C. for around 48 hours. Further, by using a thin layer of the sample (stems), the sample did not need to be mixed as the sample was exposed to the heat evenly. In other cases, if the amount of sample was a very thick layer, then the sample needed to be turned around twice daily. It was found that a slower drying process may be preferable to retain a desired color and flavor profile. The drying process may be changed with temperature and duration to get a final moisture of less than 10% for final product stability. Once the sample had dried and included a crunchy texture, the drying was done, and the sample was removed.

It was noted that the collards did not do very well with the very thick layer method, as the slow exposure to warm, dry air tended to leach out the moisture, and a puddle of water formed under the sample. In this case, there was no set time, as the amount of the sample (e.g., a thick layer) affected how quickly it dried. It was found that kale did not appear to take as long to dry as the collards.

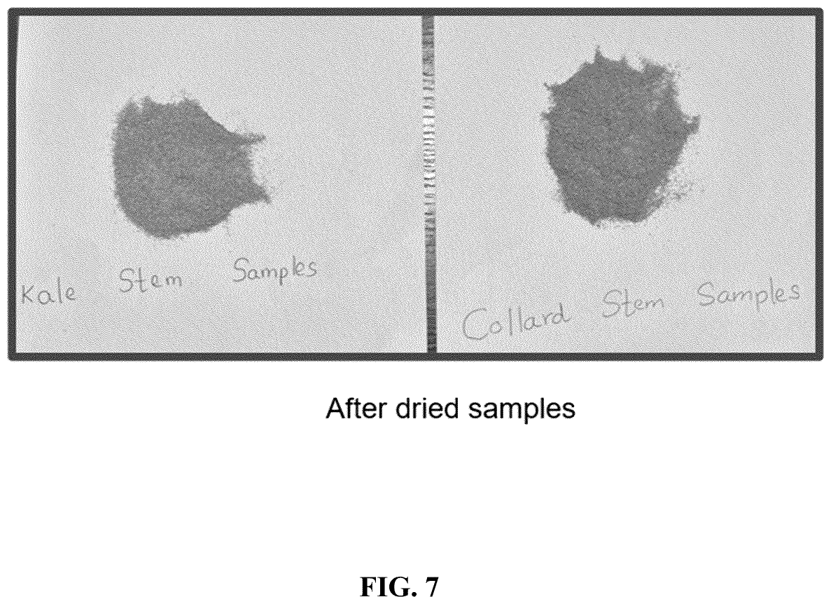

Drying was performed at 60° C. for 100 g and 300 g of both kale and collard stems. See Table 1 for conditions. As illustrated in FIG. 7, the resulting powders maintain a green color.

TABLE 1
Optimized drying conditions

| | Optimized | Average | Energy |
|---|---|---|---|
| Sample Weight | Time to Dry | Moisture % | (kWh) |
| Kale stems 100 g | 145 min | 10.41 | 0.00365 |
| Kale stems 300 g | 170 min | 10.41 | 0.01093 |
| Collard stems 100 g | 145 min | 11.34 | 0.00360 |
| Collard stems 300 g | 190 min | 10.63 | 0.01092 |

The average unit price of electricity for the testing location (South Carolina) is 6.25 cents/1 kWh. The power for drying a 100 g sample at 60° C. equals 0.00360 kWh. For an industrial sample weight of 1 Megaton (Mts) the estimated energy cost of drying equals $22.50.

### Example 3

### Solar Heat Drying Process

In a further aspect, solar drying the food material can be utilized. Solar drying is beneficial for cost reduction and environmental concerns. Localized drying can also reduce transportation costs by decreasing the density of the food, and it may increase the life of the food material by drying shortly after harvesting rather than transportation to an industrial drying facility.

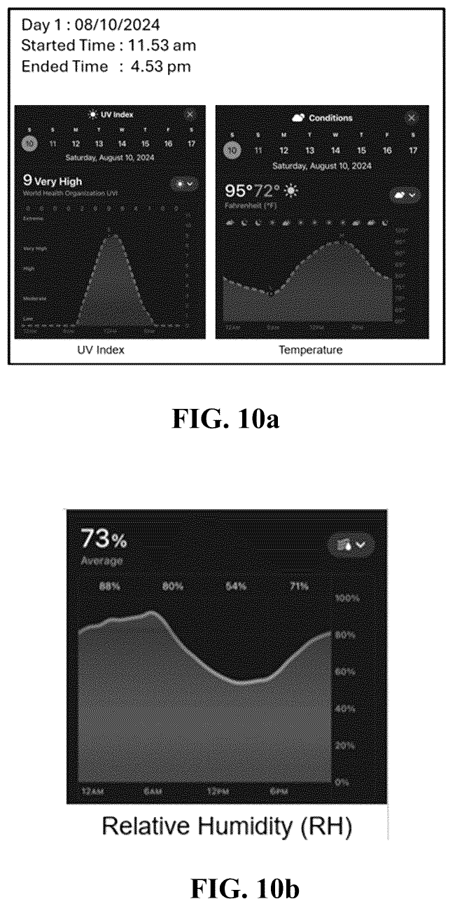

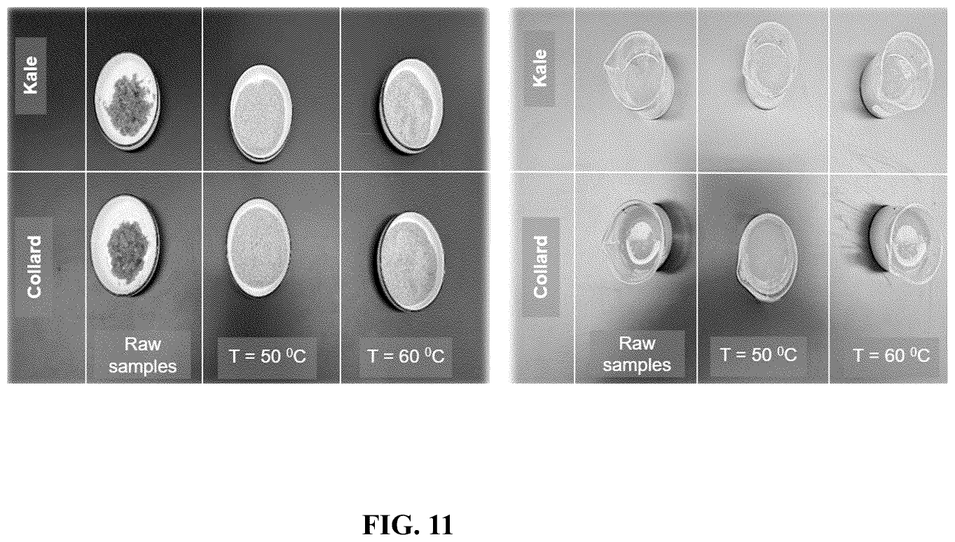

FIG. 8 and FIG. 9 illustrate the drying process using solar heating. 100 g (top) and 300 g samples of both kale and collard from t=0 to t=5 hours. The 300 g were further dried to a timepoint of 6.5 hours. FIGS. 10a and 10b provides the environmental conditions. The UV index for Day 1 was 9, which led to decolorizing of the food material, and the resulting powder (FIG. 9) is not as green as the starting material. If a greener end-product is desired, the material can be dried under a lower UV index. Table 2 shows the optimized drying times for each mass and stem type.

TABLE 2
Optimized solar drying conditions

| Sample Weight | Optimized Time to Dry | Average Moisture % |
|---|---|---|
| Kale stems 100 g | 240 min | 8.60 |
| Kale stems 300 g | 390 min | 10.04 |
| Collard stems 100 g | 240 min | 8.47 |
| Collard stems 300 g | 390 min | 10.39 |

### Example 4

### Process Steps: The Milling Process

Upon completion of the drying process, the sample was placed back into the Hamilton Beach food processor with the S-blade. The sample was fed into the processor through the chute. The sample was then ground in the processor at a high speed. The sample that was ground in the processor was then sieved through a mesh strainer. Any sample that remained in the strainer was placed back into the processor and ground once again. The remaining sample was then sieved through the mesh strainer. The resultant sample was a fine powder, i.e., a flour.

### Example 5

### Nutrition and Composition Profiles of the Resultant Sample

TABLE 3

| | Kale Flour | Collard Flour |
|---|---|---|
| Moisture (%) | <10 | <10 |
| Protein (wt-%) | 15-30 | 15-30 |
| Fat (wt-%) | <5 | <5 |
| Ash (wt-%) | 1-20 | 1-20 |
| Carbohydrates (wt-%) | 40-60 | 40-60 |
| Dietary Fiber (wt-%) | 40-60 | 40-60 |
| Sodium (mg/100 g) | <100 | <100 |
| Potassium (mg/100 g) | 1000-6000 | 1000-6000 |
| Calcium (mg/100 g) | 1000-2500 | 1000-2500 |
| Iron (mg/100 g) | 1-10 | 1-10 |

As shown within the results of Table 3, when the samples have been processed at 60° C. for around 48 hours, the moisture content of the resulting kale flour and collard flour is less than 10%. The protein composition of the resulting kale flour and collard flour falls between 15% and about 30%, and the dietary fibers of the resulting kale flour and collard flour fall between around 40% and around 60%. The resulting kale flour and collard flour each include between around 10% and about 15% fats, and remaining minerals and vitamin micronutrients.

### Example 6

### Color Retainment Test Through Rehydration

Kale and collard material that was dried at 50° C. and 60° C. was ground to a flour and then rehydrated. FIG. 10 shows that the natural green color was retained within the flour using the drying methods as described in preceding examples.

### Example 7

### Comparison Studies with Commercial Flour

Flour manufactured using methods of the present invention (Sample 1) was compared with two commercial kale flours, Food to Live® Kale Powder (Sample 2) and Koyah™ Kale Powder (Sample 3).

### Comparison Study 1: Water Solubility

Water solubility is essential for liquid food applications such as smoothies and juices. Approximately three grams of each flour were dissolved in 56 grams of water, stirred for three minutes, and left at room temperature. After 30 minutes, Sample 1 showed better solubility and homogeneity than Samples 2 and 3, which exhibited clear phase separation.

### Comparison Study 2: High Centrifuge and High Gravity Mixing

The same three samples were mixed with a speed mixer at 3250 rpm for 45 seconds after a 1:20 dilution. Sample 1 demonstrated better homogeneity and stability, remaining in solution after 30 minutes at room temperature.

Sample 1 had superior water solubility and stability at room temperature compared to Samples 2 and 3.

### Comparison Study 3: Determination of Additives, Including Color Enhancing Materials

The solutions of Sample 1 and Samples 2 and 3 supernatants were mixed with an equal volume of hexane to detect added colorants. The hexane extract of Sample 1 showed no colorant solubility, while Samples 2 and 3 exhibited intense green color, indicating the presence of added organic green colorants.

### Comparison Study 4: Fourier Transform Mid Infrared Spectroscopy Analysis (FTMIR)

The flours of all three samples were analyzed using FTMIR and Ultraviolet Visible (UV) Spectroscopy. Samples 2 and 3 showed unique fingerprint regions and UV intensities, indicating the presence of IR and UV-active organic molecules. No such observations were made for Sample 1.

Conclusions: Samples 2 and 3 contained color-enhancing additives, possibly unique organic molecules not soluble in water but soluble in hexane.

### Comparison Study 5: Nutrition Profile Analysis

Protein and dietary fiber analyses were conducted using FTMIR. Sample 1 had higher protein and dietary fiber content than Samples 2 and 3.

Conclusions: Sample 1 is naturally rich in protein and dietary fiber. The lower protein and dietary fiber content in Samples 2 and 3 may indicate the presence of added sugars or carbohydrates.

Although the various embodiments have been described with reference to preferred implementations, persons skilled in the art will recognize that changes may be made in form and detail without departing from the spirit and scope thereof.

What is claimed is:

1. A method of converting produce to an edible fine powder, the method comprising:
providing a starting material comprising an agricultural produce;
cutting the agricultural produce to form smaller pieces of the agricultural produce to increase a surface area of the smaller pieces of the agricultural produce;
drying the smaller pieces of the agricultural produce to reduce a moisture content of the smaller pieces of the agricultural produce;
grinding the smaller pieces of the agricultural produce into a fine powder; and
passing the fine powder through a sieve.

2. The method of claim 1, wherein the drying of the smaller pieces of the agricultural produce reduces the moisture content of the smaller pieces of the agricultural produce to a moisture content of less than about 15%.

3. The method of claim 1, wherein the agricultural produce comprises kale stems or collard stems.

4. The method of claim 1, wherein the fine powder is a flour comprising protein in an amount of between about 5 wt-% to about 30 wt-%.

5. The method of claim 1, wherein the drying of the smaller pieces of the agricultural produce occurs at a temperature of about 50° C. (Celsius) to about 100° C.

6. The method of claim 1, wherein the drying of the smaller pieces of the agricultural produce occurs over a time period of about 6 hours to about 48 hours.

7. The method of claim 1, wherein the smaller pieces of the agricultural produce are less than or equal to about one inch in length.

8. The method of claim 1, wherein the fine powder is a flour comprising dietary fiber in an amount of between about 40 wt-% to about 70 wt-%.

9. The method of claim 8, wherein the flour comprises fats, minerals, vitamin micronutrients, or a combination thereof, in an amount of between about 5 wt-% and about 15 wt-%.

10. A method of converting produce to an edible fine powder, the method comprising:
providing a starting material comprising an agricultural produce;
cutting the agricultural produce to form smaller pieces of the agricultural produce to increase a surface area of the smaller pieces of the agricultural produce, wherein the smaller pieces of the agricultural produce are less than or equal to one inch in length;
drying the smaller pieces of the agricultural produce to reduce a moisture content of the smaller pieces of the agricultural produce to less than 15%;
grinding the smaller pieces of the agricultural produce into a fine powder via a milling process; and
passing the fine powder through a sieve.

11. A composition for animal consumption, the composition comprising flour, wherein at least 80% weight/volume of the flour is derived from secondary food portions.

12. The composition of claim 11 wherein the secondary food portions are comprised of one or more of kale stems, collard stems, and collard stalks.

13. The composition from claim 12 wherein at least 90% weight/volume of the flour is derived from one or more of kale stems, collard stems, and collard stalks.

14. The composition of claim 13 wherein at least 95% weight/volume of the flour is derived from one or more of kale stems, collard stems, and collard stalks.

15. The composition of claim 11 wherein the animal consumption is human consumption.

16. The composition of claim 12 wherein the secondary food portions are comprised of kale stems.

17. The composition of claim 12 wherein the secondary food portions are comprised of collard stems and collard stalks.

18. The method of claim 1 wherein the drying is performed using solar heating.

19. The composition of claim 11 wherein the composition is in a liquid consumable.

20. The composition of claim 11 wherein the composition is green and does not contain dyes or coloring components.
